(19) United States
(12) Patent Application Publication
(10) Pub. No.: US 2024/0154312 A1
(43) Pub. Date: May 9, 2024

(54) SINGLE FEED AND DUAL POLARIZATION ANTENNA

(71) Applicant: ROGERS CORPORATION, Chandler, AZ (US)

(72) Inventors: Shailesh PANDEY, Woburn, MA (US); Yajie CHEN, Brighton, MA (US); Lance YOUNG, Shrewsbury, MA (US)

(21) Appl. No.: 18/382,798

(22) Filed: Oct. 23, 2023

Related U.S. Application Data
(60) Provisional application No. 63/422,096, filed on Nov. 3, 2022.

(51) Int. Cl. H01Q 9/04; G01S 19/13; H01Q 1/36

(52) U.S. Cl. CPC H01Q 9/0428; G01S 19/13; H01Q 1/364

(57) ABSTRACT

An antenna includes: a substrate having a magnetodielectric material; and, an electromagnetic, EM, radiator having an electrically conductive material disposed on an upper surface of the substrate, the EM radiator including a plurality of chamfered sides extending contiguously from one another to define an octagon-shaped EM radiator.

### CROSS REFERENCE TO RELATED APPLICATIONS

This application claims the benefit of U.S. Provisional Application Ser. No. 63/422,096, filed 3 Nov. 2022, which is incorporated herein by reference in its entirety.

### BACKGROUND

The present disclosure relates generally to antennas, and more particularly to single feed, dual band dual polarization antennas.

Applications involving emergency calling (eCall) and autonomous driving require precise point positioning and tracking of at least two frequency bands from multiple satellite constellations. While existing antennas may be suitable for their intended purpose in such applications, there remains a need for an improved antenna in a more compact design.

### BRIEF SUMMARY

A non-limiting embodiment includes an antenna as defined by the appended independent claims. Further advantageous modifications of the antenna are defined by the appended dependent claims.

According to a non-limiting embodiment, an antenna includes a single feed, dual polarization antenna with an electromagnetic (EM) radiator having chamfered sides that define an octagon-shaped EM radiator, wherein the chamfered sides are defined according to a chamfer function which controls the radiating modes of the EM radiator at specific frequencies.

According to another non-limiting embodiment, an antenna includes a substrate and an electromagnetic (EM) radiator. The substrate is formed from a magnetodielectric material. The EM, radiator includes an electrically conductive material disposed on an upper surface of the substrate. The EM radiator includes a plurality of chamfered sides extending contiguously from one another to define an octagon-shaped EM radiator.

According to another non-limiting embodiment, an antenna assembly comprises an antenna and a host board. An antenna assembly includes an antenna and a host board. The antenna includes a substrate and an electromagnetic (EM) radiator. The substrate is formed from a magnetodielectric material. The EM, radiator includes an electrically conductive material disposed on an upper surface of the substrate. The EM radiator includes a plurality of chamfered sides extending contiguously from one another to define an octagon-shaped EM radiator. The host board includes an upper dielectric surface and a lower dielectric surface located opposite the upper dielectric surface. The substrate is disposed on the upper dielectric surface.

According to yet another non-limiting embodiment, an antenna includes a substrate and an electromagnetic (EM) radiator. The substrate can comprise of a magnetodielectric material. The magnetic property of material can facilitate miniaturizing the antenna design while also improving various antenna performance characteristics including radiation, matching bandwidth and/or polarization. The EM radiator can comprise of an electrically conductive material disposed on an upper surface of the substrate. The EM radiator includes a plurality of chamfered sides extending contiguously from one another to define an octagon-shaped EM radiator. The chamfered sides are configured to control the performance of the antenna for multi-band operations.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered or illustrated alike in the accompanying Figures:

FIG. 1 depicts a comparison of performance coverage between an example current coverage scenario and an example improved coverage scenario, in accordance with an embodiment;

FIG. 2 depicts a plan view of an antenna assembly including an example design antenna with example design specifications, in accordance with an embodiment;

FIG. 3 depicts a table of other specifications for the example design antenna of FIG. 2 for dual band performance, in accordance with an embodiment;

FIG. 4 depicts a rotated isometric view of the antenna assembly including the example design antenna of FIG. 2, in accordance with an embodiment;

FIG. 5 depicts the example design antenna of FIGS. 2 and 4 in accordance with an embodiment;

FIG. 6 depicts a plan view of the example design antenna of FIG. 5 with example fabrication details, in accordance with an embodiment;

FIG. 7 depicts reflection coefficient characteristics of the example design antenna of FIGS. 2 and 4, in accordance with an embodiment;

FIG. 8 depicts efficiency characteristics of the example design antenna of FIGS. 2 and 4, in accordance with an embodiment;

FIG. 9 depicts gain characteristics of the example design antenna of FIGS. 2 and 4, in accordance with an embodiment;

FIG. 10 depicts axial ratio characteristics of the example design antenna of FIGS. 2 and 4, in accordance with an embodiment;

FIG. 11 depicts an example of band coverage operating ranges of the example design antenna of FIGS. 2-6, in accordance with an embodiment.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

The following examples are provided to illustrate the present disclosure. The examples are merely illustrative and are not intended to limit devices made in accordance with the disclosure to the materials, conditions, or process parameters set forth therein.

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

Precise point positioning for GPS (Global Positioning System) frequencies greater than the GPS L2 band in autonomous driving applications requires tracking of at least two frequency bands from multiple satellite constellations, such as for example GPS L5 and Galileo E5b. Existing multiband GPS antennas typically combine a single GPS L5 and GPS L1 band, but do not address multiple satellite constellations, unless the antenna is large (for example 50 mm×50 mm or 70 mm×70 mm). By increasing the instantaneous bandwidth of each patch antenna, a single antenna can be made to cover at least two, and potentially three constellations, with two bands in each. In the prior art, a first current coverage scenario spans the GPS L5 and Galileo E5b bands but not the GPS L2 band, and a second current coverage scenario spans the BDS B2, GPS L1, and GLO L1, bands. As discussed herein below, an improved coverage scenario of an antenna as disclosed herein spans the GPS L5 and GPS L2 bands, and discriminates out the Galileo E5b band.

Various non-limiting embodiments described herein provide a patch antenna including a single layer substrate which has magneto-dielectric property with specific permittivity and permeability values at the band of frequencies. The patch antenna includes a plurality of chamfered sides that defines octagon-shape patch antenna. The chamfered sides can control the performance of the antenna, e.g., the resonance behavior of the antenna, for multi-band operations. The shape defined by the chamfered sides and the single substrate facilitates the cancellation of electric current as well as the magnetic current, which prevents destruction of the radiation behavior at the multiple resonating bands. In addition, the magnetic property of material helps facilitates miniaturizing the antenna design while improving the performance characteristics including, but not limited to, radiation, matching bandwidth and polarization behavior.

The antenna can be used for over a wide range of the GPS frequency band such as, for example, L1 C/A, L2C, L2P and L5; GLONASS: LYC/A and L3 OC; Galileo: E1, E1a, E5b, E5 AltBOC; BeiDou: B11, B21, B1C, B2a, B2b; SBAS: L1 and L5; NAVIC: L5; and QZSS: L1 C/A, L1C, L1S, L2C and L5. According to one or more non-limiting embodiments, the antenna operates over a wide impedance bandwidth such as, for example, about 1170 MHz to about 1240 MHz (e.g., a range of about 70 MHz), and about 1530 MHZ to about 1650 MHz (e.g., a range of about 120 MHz). The antenna described according to various non-limiting embodiments also can operate at a higher radiation efficiency of about 60% for multi-bands of operation. One or more non-limiting embodiments also provides an antenna that operates according to a broad efficiency bandwidth (e.g., about 115 MHz at L5 and L2 band, and about 180 MHz at L1 band) with an efficiency above 50%.

A prototype antenna design in accordance with one or more non-limiting embodiments disclosed herein was fabricated on a magnetodielectric material with achieved properties (i.e., permittivity, and permeability with loss) developed in the laboratory. The goal was to use the material and demonstrate the miniaturization of the antennas for specific applications. According to one or more non-limiting embodiments, the magnetodielectric material can include a hexagonal ferrite particles and PTFE or PPS polymer. The hexagonal ferrite material can include Z-type (Co2Z), or Y-type (Co2Y) hexaferrite

The technical application herein mentioned is for GPS (Global Positioning System). The GPS bands for which the disclosed antenna is operational includes different bands such as, for example, GPS L1, GPS L2 and GPS L5 bands. The GPS L1 band, has a nominal center frequency of 1575.42 MHz with a bandwidth of about 15.345 MHz, the L2 band has a nominal center frequency at 1227.6 MHz with a bandwidth of about 11 MHz, and the L5 band has a nominal center frequency at 1176.45 MHz with a bandwidth of about 12.5 MHz.

The chamfered sides define a unique profile and shape, and contribute to an improved bandwidth, as well as tuning of the entire band of operation. According to one or more non-limiting embodiments, the antenna operating with the magnetic materials described herein covers a required band of operation corresponding to the lower bands of Galileo E5b and E5a.

An embodiment of the disclosed antenna design disclosed herein offers a wide impedance bandwidth of equal to or greater than 75 MHz, a gain of 3 decibels per isotropic (Dbi), a wide axial ratio bandwidth of 3 dB, a radiation efficiency of equal to or greater than 50%. The design was made on a single layer magnetodielectric material substrate, as compared to existing stacked layers of similar commercial antenna designs in the market. According to one or more non-limiting embodiments, the magneto material substrate is formed as a monolithic substrate comprising a magnetodielectric material. As used herein, the term monolithic means a structure integrally formed from a single material composition.

An embodiment of the disclosed antenna includes chamfered sides that defines substantially octagon-shaped patch antenna, which is disposed on a magnetodielectric substrate with a dielectric property having both permittivity and permeability values. The advantage of the magnetodielectric substrate is the presence of an electric current as well as a magnetic current, when electromagnetically excited, because the materials constituent of permeability is utilized to improve the antenna performances like radiation and matching bandwidth. The permittivity and permeability values contribute to the miniaturization factor of an antenna disclosed herein. An advantage of the antenna design is the material property, which contributes to the miniaturization of the antenna and leads a design that achieves the desired antenna performance characteristics.

The magnetodielectric substrates suitable for a purpose disclosed herein may be a magnetic particle or magnetic particle-polymer composite. As described herein, the magnetodielectric material can include hexagonal ferrite particles and PTFE or PPS polymer. The hexagonal ferrite material can include Z-type (Co2Z), or Y-type (Co2Y) hexaferrite. In an embodiment, the magnetic permittivity (ε) is equal to or greater than 4 and equal to or less than 5, and alternatively equal to 4.96, the permeability (μ) equal to or greater than 1.0 and equal to or less than 2.0, and alternatively equal to 1.61, the first loss tangent parameter (e.g., a dielectric loss tangent) (tan δ) is equal to or greater than 0.005 and equal to or less than 0.01, and alternatively is equal to 0.009, and a second loss tangent parameter (e.g., a magnetic loss tangent) (tan μ) over a frequency band of 100 MHz to 2 GHz. In an embodiment, the magnetodielectric composite can comprise a magnetic filler (ferrite or metallic particle) of 10-80 vol %, and polymer of 20-90 vol %.

An example magnetodielectric substrate found to be useful for a purpose disclosed herein is Ba1.5Sr1.5Co2.12Mo0.12Fe22.16O41, 45 vol % ferrite, 55 vol % LDPE. This particular magnetodielectric substrate has the following properties at 1.21 GHz: permittivity (ε) equal to 4.96, permeability (μ) equal to 1.61; a dielectric loss tangent (tan δ) equal to 0.009, and a magnetic loss tangent (tan μ) equal to 0.03.

At least one non-limiting embodiment, as shown and described by the various figures and accompanying text, provides a single band antenna useful, for example, in eCall and autonomous driving applications. Another application that is contemplated is in a six-band Global Navigation Satellite System (GNSS) chipset for automotive applications.

While embodiments illustrated and described herein depict an example single band antenna having chamfered sides that define an electrically conductive patch having a particular two-dimensional (2D) plan view octagon shape, it will be appreciated that this geometry is merely one example of many geometries that may be employed in the design of a single band antenna as disclosed herein depending on the desired performance characteristics (polarization, operating frequencies, bandwidths, gains, return losses, radiation patterns, etc.) of the single band antenna. It will also be appreciated that the disclosed geometry may be modified without departing from a scope of the invention. As such, the disclosure herein applies to any single band antenna design that falls within the ambit of the appended claims, and any 2D geometry of the electrically conductive patch that falls within the ambit of the disclosure herein, and is suitable for a purpose disclosed herein, is contemplated and considered to be complementary to the particular embodiments disclosed herein.

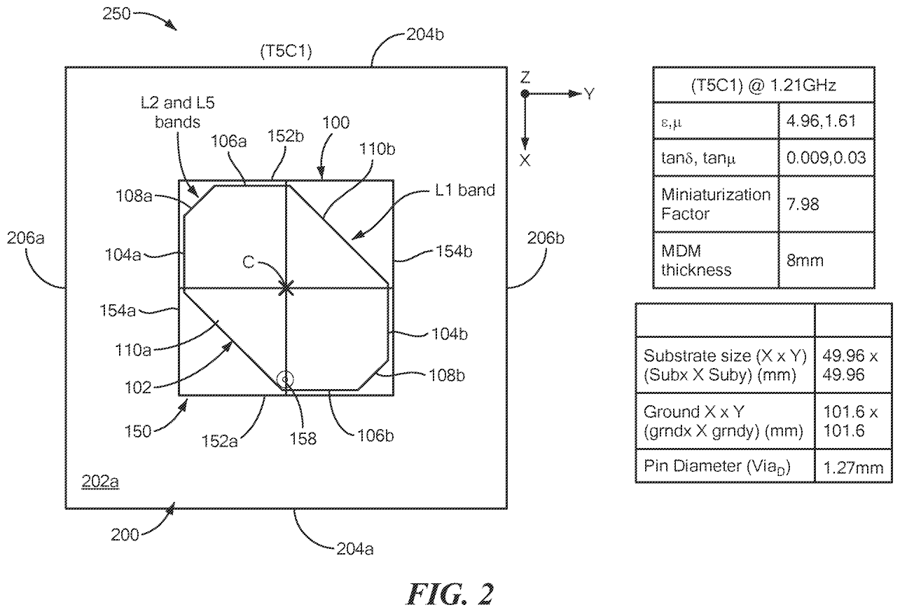

Reference is now made to FIGS. 2-11. Like features depicted in FIGS. 2, 4, 5, and 6, having like reference numerals should be referenced in combination.

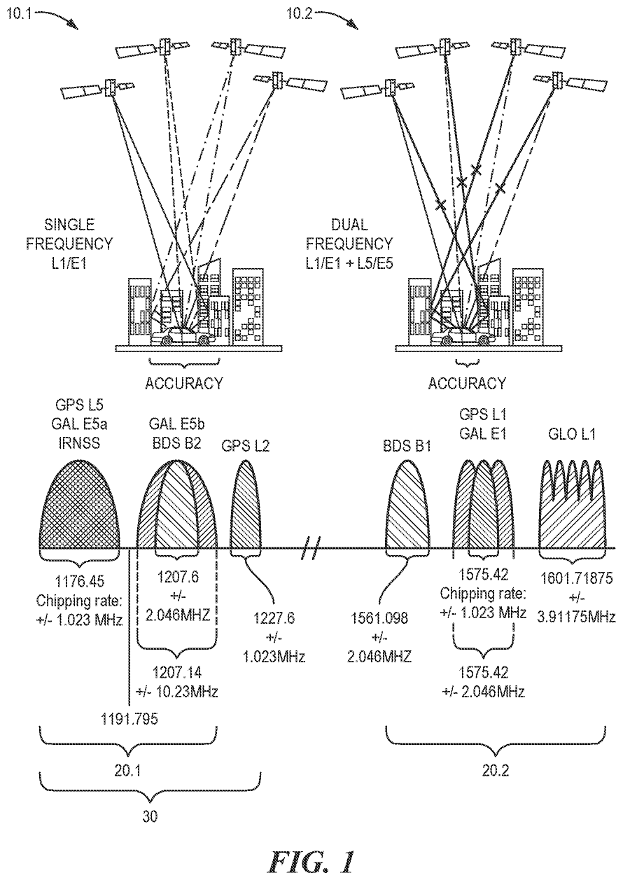

FIG. 1 depicts a comparison of performance coverage between example current coverage scenarios 20.1, 20.2 and an example improved coverage scenario 30. Precise point positioning for GPS (Global Positioning System) 10.1, 10.2 frequencies greater than the GPS L2 band in autonomous driving applications requires tracking of at least two frequency bands from multiple satellite constellations, such as for example GPS L5 and Galileo E5b. Existing multiband GPS antennas typically combine a single GPS L5 and GPS L1 band into a stacked patch antenna, but do not address multiple satellite constellations, unless the antenna is large (for example 50 mm×50 mm or 70 mm×70 mm). By increasing the instantaneous bandwidth of each patch antenna, a single antenna can be made to cover at least two, and potentially three constellations, with two bands in each. As depicted, a first current coverage scenario 20.1 corresponding to GPS 10.1 spans the GPS L5 and Galileo E5b bands but not the GPS L2 band, and a second current coverage scenario 20.2 corresponding to GPS 10.2 spans the BDS B2, GPS L1, and GLO L1, bands. As further depicted, an improved coverage scenario 30 corresponding to GPS 10.1 of an antenna as disclosed herein spans the GPS L5 and GPS L2 bands, and discriminates out the Galileo E5b band.

FIG. 2 depicts a plan view of an example design antenna 100 coupled to a host board 200 to form an antenna assembly (T5C1) 250 with example design specifications (T5C1 @ 1.21 GHz). While particular specifications are defined, it will be appreciated that these are for example only, and may be modified depending on the desired antenna performance characteristics for a particular application. The antenna 100 is operational over at least three frequency bands, and is operational to discriminate frequencies between individual ones of the at least three frequency bands. According to a non-limiting embodiment, a first of the at least three frequency bands is the L5 band, a second of the at least three frequency bands is the L2 band, and a third of the at least three frequency bands is the L1 band. According to a non-limiting embodiment, the L5 band is operational at a nominal center frequency of 1.176 GHz with a bandwidth of 12.5 MHz, the L2 band is operational at a nominal center frequency of 1.227 GHz with a bandwidth of 11 MHz, and the L1 band is operational at a nominal center frequency of 1.575 GHz with a bandwidth of 15.3 MHz. The structure of the resonator 102 that controls the L5, L2, and L1, frequency band operational characteristics of the antenna 100 is discussed further herein below. Other enumerated features depicted in FIG. 2 are discussed further herein below in combination with other figures having like features.

The antenna 100 can operate with a gain equal to or greater than 3 dBi at each respective operational band, an axial ratio equal to or less than 6 dBi, alternatively equal to or less than 3 dBi, at +/−30-degrees from each radiation boresight of the antenna 100, and an efficiency of equal to or greater than 50%. According to one or more non-limiting embodiments, the antenna 100 is operational with right-hand-circular-polarization.

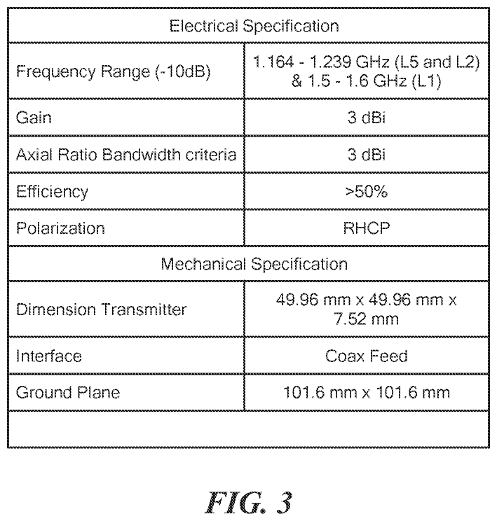

FIG. 3 depicts a table of other specifications for the example design antenna 100 of FIG. 2 in accordance with an embodiment disclosed herein. While particular specifications are defined, it will be appreciated that these are for example only, and may be modified depending on the desired antenna performance characteristics for a particular application.

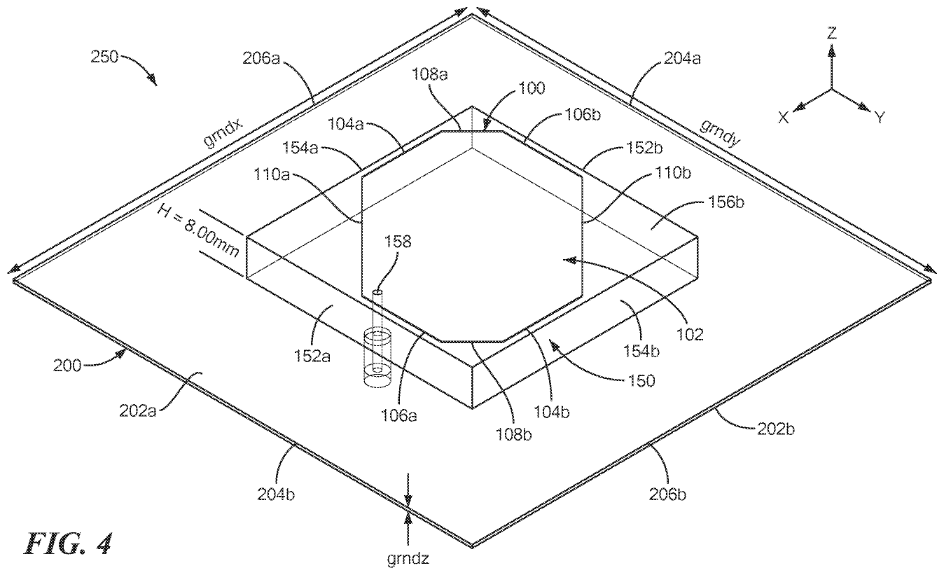

FIG. 4 is an isometric view of the antenna assembly 250 in accordance with one or more non-limiting embodiments. As described herein, the antenna assembly 250 includes the antenna 100 in the form of an octagonal patch EM radiator 102, the substrate 150, which in an embodiment is a magnetodielectric material (MDM), and a host board 200. The host board 200 includes an upper dielectric surface 202a and a lower dielectric surface 202b located opposite the upper dielectric surface 202a. In an embodiment, the substrate 150 of the antenna 100 is disposed on the upper dielectric surface 202a of the host board 200.

According to a non-limiting embodiment, the host board 200 extends along a first axis (e.g., X-axis) from a first board end 204a to an opposing second board end 204b to define a board length, grndx, extends along a second axis (e.g., Y-axis) from a third board end 206a to an opposing fourth board end 206b to define a board width, grndy, and extends along a third axis (e.g., Z-axis) from the lower dielectric surface 202b to the upper dielectric surface 202a, to define a board thickness, grndz. The X, Y, and Z, axes forming an orthogonal X-Y-Z coordinate system.

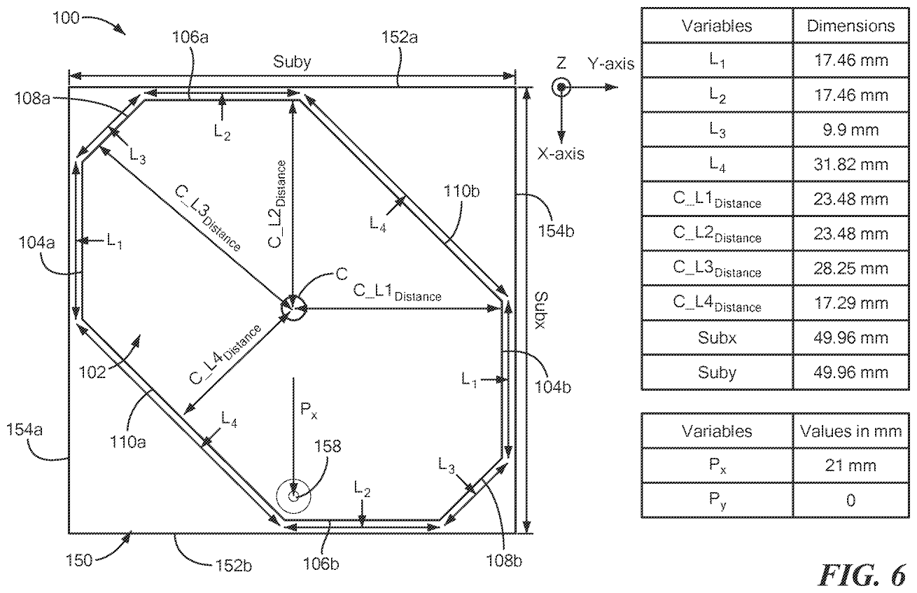

With continued reference to FIG. 4, the antenna assembly 250 includes an electrically conductive via 158 extending through the EM radiator 102, the substrate 150, and the host board 200, to establish electrical conductivity with the EM radiator 102 and the substrate 150. According to a non-limiting embodiment, the via 158 has a circular profile defining a via diameter, Via_{D}. The via diameter, Via_{D}, can be equal to or greater than 0.5 mm and equal to or less than 3.0 mm, alternatively is equal to or greater than 1.0 mm and equal to or less than 2.0 mm, and further alternatively is equal to 1.27 mm. The via 158 is located a distance away from a center point, C (see FIGS. 2 and 6 for example), of the EM radiator 102 to define a via distance, P_{X} (see FIG. 6 for example). The via distance can be equal to or greater than 19.0 mm and equal to or less than 23.0 mm, alternatively is equal to or greater than 20.0 mm and equal to or less than 22.0 mm further alternatively is equal to 21.0 mm.

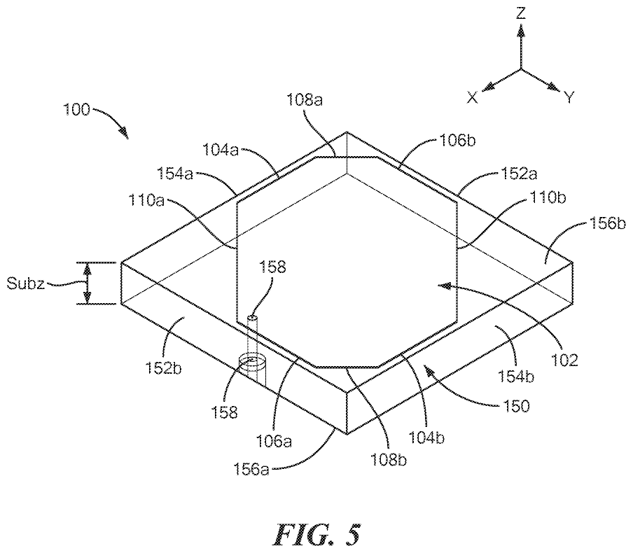

FIG. 5 depicts a rotated isometric view of the example design antenna 100 illustrated in FIGS. 2 and 4. The antenna 100 includes a substrate 150 and an electromagnetic, EM, radiator 102. According to a non-limiting embodiment, the substrate 150 is formed as a single layer of magnetodielectric material. In one or more non-limiting embodiments, the magnetodielectric material comprises a hexagonal ferrite particles and Polytetrafluoroethylene (PTFE) or Polyphenylene sulfide (PPS) polymer. In some non-limiting embodiments, the hexagonal ferrite material includes, but is not limited to, Z-type (Co2Z), or Y-type (Co2Y) hexaferrite.

With reference to FIGS. 5 and 6, the substrate 150 extends from a first substrate end 152a to an opposing second substrate end 152b along the first axis, X-axis, to define a substrate length, Subx, and extends from a third substrate end 154a to a fourth substrate end 154b along the second axis, Y-axis, to define a substrate width, Suby, and further extends from a lower substrate surface 156a to an upper substrate surface 156b along the third axis, Z-axis, to define a substrate thickness, Subz. According to a non-limiting embodiment, the substrate length, Subx, is equal to or greater than 47.0 mm and equal to or less than 50.0 mm, alternatively is equal to or greater than 48.0 mm and equal to or less than 49.0 mm, and further alternatively is equal to 49.96 mm, the substrate width, Suby, is equal to or greater than 47.0 mm and equal to or less than 50.0 mm, alternatively is equal to or greater than 48.0 mm and equal to or less than 49.0 mm, and further alternatively is equal to 49.96 mm; and the substrate thickness, Subz, is equal to or greater than 6.0 mm and equal to or less than 10.0 mm, alternatively is equal to or greater than 7.0 mm and equal to or less than 9.0 mm, and further alternatively is equal to 8.0 mm. Here, the example dimensions for the substrate thickness were used for analytically modeling the performance characteristics of the design antenna. It should be appreciated that the dimensions of the substrate may be varied without departing from the scope of the invention. In addition while a particular substrate thickness is presented, it will be appreciated that this is for example only, and may be modified depending on the desired antenna performance characteristics for a particular application.

In an embodiment, the EM radiator 102 comprises an electrically conductive material disposed on an upper surface 156b of the substrate 150 to form a patch antenna, for example. In and embodiment, the EM radiator 102 includes a plurality of chamfered sides 104a, 104b, 106a, 106b, 108a, 108b, 110a, 110b (best seen with reference to FIG. 6), which extend contiguously from one another to define an octagon-shaped EM radiator 102. According to a non-limiting embodiment, a first chamfered side 104a is arranged adjacent to the third substrate end 154a. A second chamfered side 104b is arranged opposite and parallel to the first chamfered side 104a and is adjacent to the fourth substrate end 154b. A third chamfered side 106a is arranged adjacent to the first substrate end 152a. A fourth chamfered side 106b is arranged opposite and parallel to the third chamfered side 106a and is adjacent to the second substrate end 152b. A fifth chamfered side 108a extends from the first chamfered side 104a to the third chamfered side 106a. A sixth chamfered side 108b is arranged opposite and parallel to the fifth chamfered side 108a and extends from the second chamfered side 104b to the fourth chamfered side 106b. A seventh chamfered side 110a extends from the first chamfered side 104a to the fourth chamfered side 106b. An eighth chamfered side 110b is arranged opposite and parallel to the seventh chamfered side 110a and extends from the third chamfered side 106a to the second chamfered side 104b.

FIG. 6 depicts a plan view of the example design antenna 100 with example fabrication details presented. Here, particular dimensions for the EM radiator 102, the chamfered sides of the EM radiator, and the substrate are presented While particular dimensions are presented, it will be appreciated that these are for example only, and may be modified depending on the desired antenna performance characteristics for a particular application.

As illustrated in FIG. 6, the L4 (side length) controls the L1 Band i.e., Bandwidth of L1 Band (−10 dB crossing). The side lengths L1 and L2 control the resonance frequency of L2 and L5 Band. The perturbation segments (edge truncation or chamfer) are unique for defining the profile of the EM radiator 102 because their profiles define and control circular polarization (CP) of the antenna 100 using a single feed. These segments (L3 and L4) when taken all together can generate orthogonal radiating modes on the patch antenna to create the CP, e.g., the right hand circular polarization (RHCP).

The first and second chamfered sides 104a and 104b extend along the first axis, X-axis, to define a first side length, L1, and the third and fourth chamfered sides 106a and 106b extend along the second axis, Y-axis, to define a second side length, L2. The fifth chamfered side 108a extends from the first chamfered side 104a to the third chamfered side 106a at a distance to define a third side length, L3. The sixth chamfered side 108b extends from the second chamfered side 104b to the fourth chamfered side 106b at the distance defining the third side length, L3. The seventh chamfered side 110a extends from the first chamfered side 104a to the fourth chamfered side 106b at a distance defining a fourth side length, L4. The eighth chamfered side 110b extends from the third chamfered side 106a to the second chamfered side 104b at the distance defining the fourth side length, L4. According to one or more non-limiting embodiments, the first side length, L1, and the second side length, L2, are greater than the third side length, L3, and the fourth side length, L4, is greater than the first side length, L1, the second side length, L2, and the third side length, L3.

The distances L1, L2, L3 and L4, defined by the chamfered sides 104a, 104b, 106a, 106b, 108a, 108b, 110a, 110b control the band of operation at lower frequencies as well as higher frequencies. For example, the distances L1, L2, L3 and L4, can be varied to move the bands (e.g., narrow or widen the bands). Distance control is done by adjusting a chamfer function, sometimes referred to as “edge truncation,” defined by the arrangement of the 104a, 104b, 106a, 106b, 108a, 108b, 110a, 110b. According to one or more non-limiting embodiments, the chamfer function utilizes the vertex of the EM radiator 102 as a reference point and removes metallic portions of the EM radiator to achieve edge truncation (e.g., on the corners) of the EM radiator 102, which in turn controls the radiating modes of the EM radiator 102 at specific frequencies. For example, adjusting the chamfer function increases or decreases the effective aperture of the EM radiator 102 for a specific frequency. As described herein, the term “effective aperture” refers to the concept where the antenna 100 is resonating at a specific frequency or frequency range.

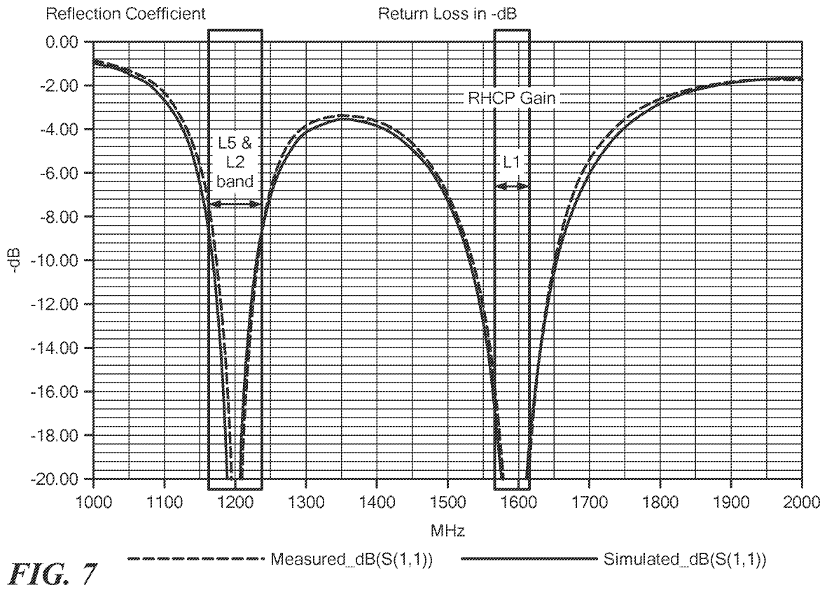

FIG. 7 depicts reflection coefficient characteristics of the example design antenna 100 described in FIGS. 2-6, in accordance with an embodiment.

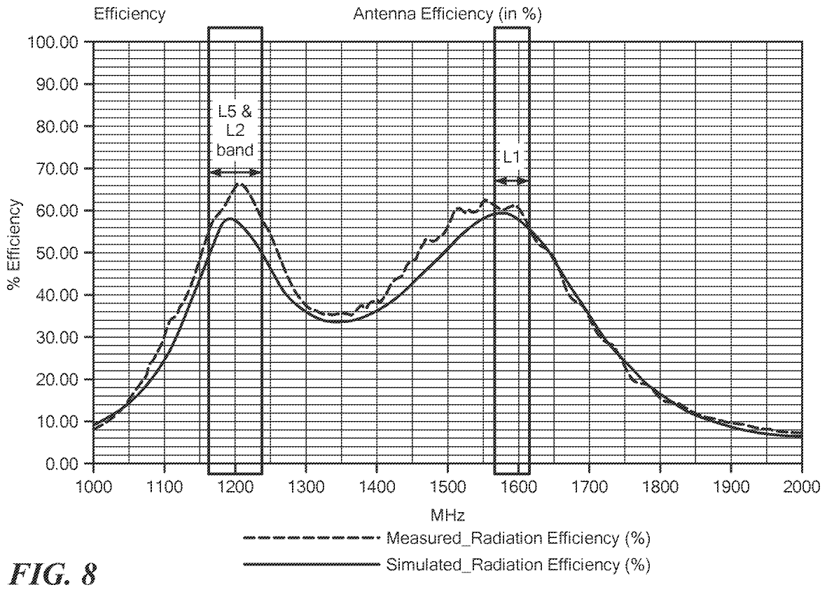

FIG. 8 depicts efficiency characteristics of the example design antenna of 100 described in FIGS. 2-6 in accordance with an embodiment. As shown in FIG. 8, the antenna 100 in accordance with various embodiments achieved an efficiency performance greater than 60% with operation within the L2 an L5 bands, i.e., 1176.45 MHz-1227.6 MHz. In addition, the antenna 100 in accordance with various embodiments achieved an efficiency performance greater than 60% with operation within the L1 band, i.e., 1561 MHz-1610 MHz.

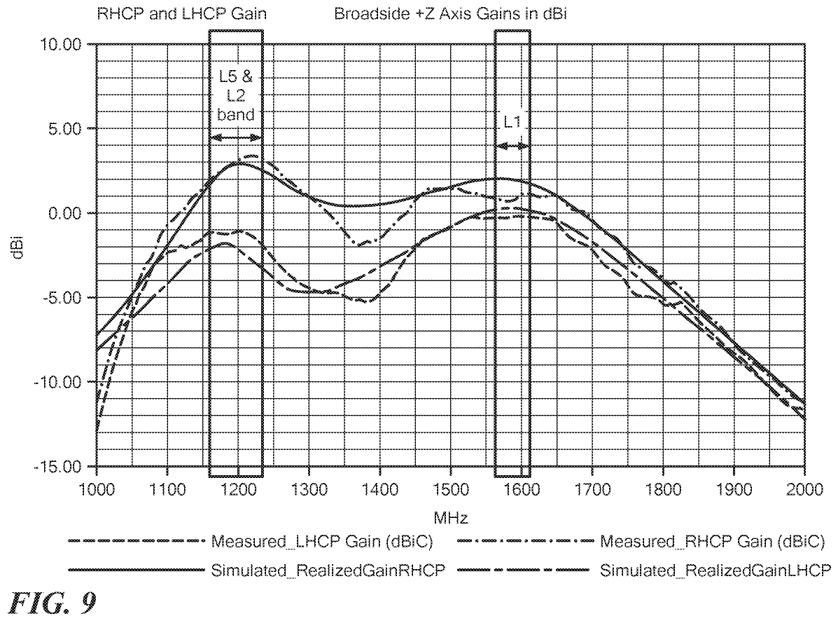

FIG. 9 depicts RHCP and LHCP gain characteristics of the example design antenna 100 described in FIGS. 2-6, in accordance with an embodiment.

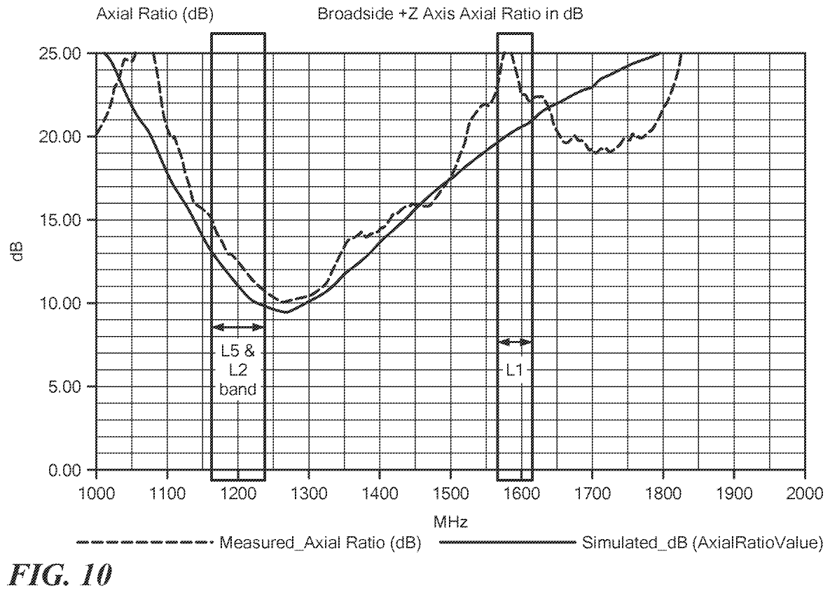

FIG. 10 depicts axial ratio characteristics of the example design antenna 100 described in FIGS. 2-6, in accordance with an embodiment.

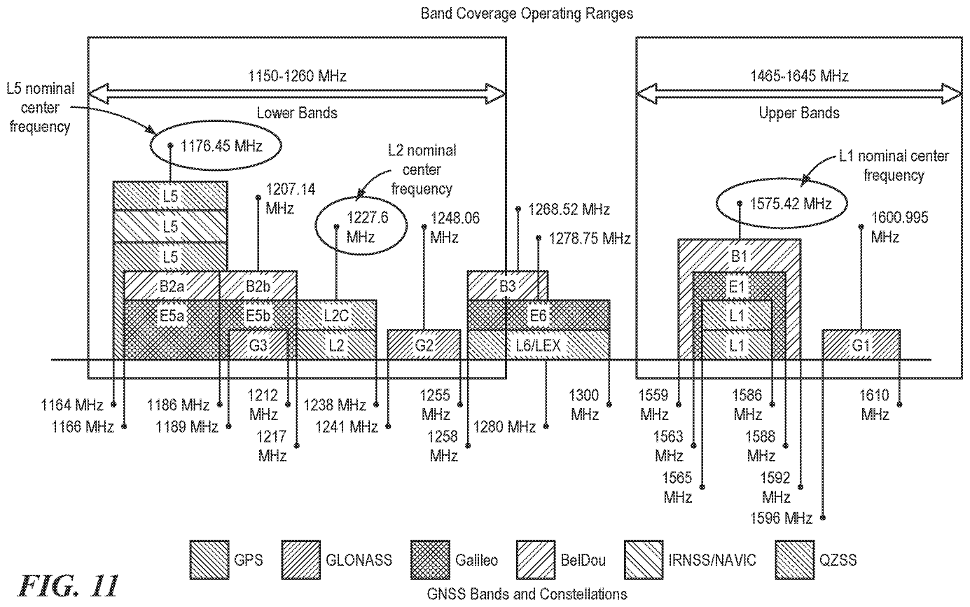

FIG. 11 depicts an example of band coverage operating ranges of the example design antenna of FIGS. 2-6, in accordance with an embodiment.

When comparing the performance characteristics of an example design antenna as disclosed herein with reference to FIGS. 2-6 against one or more existing commercial antennas used for a similar purpose, it has been found, for example, that efficiency plots show that the efficiency of some commercial antennas are not more than 50% within the L2 an L5 band i.e., 1176.45 MHz-1227.6 MHz, while measured performance characteristics of the antenna 100 described herein (see FIG. 8) is capable of achieving an efficiency greater than 60% and a maximum efficiency of 67% within the same band of operation, i.e., the L2 and L5 bands. Accordingly, the antenna 100 according to various embodiments described herein operates greater than 60% for all bands i.e., L2, L5 and L1, as compared to some existing multiband commercial antennas used for the same purpose.

With collective reference to FIGS. 1-11, it will be appreciated that various aspects of an embodiment are disclosed herein, which are in accordance with, but not limited to, at least the following aspects and/or combinations of aspects.

Aspect 1. An antenna 100, comprising: a substrate 150 comprising a magnetodielectric material; and an electromagnetic, EM, radiator 102 comprising an electrically conductive material disposed on an upper surface 156b of the substrate 150, the EM radiator 102 including a plurality of chamfered sides 104a, 104b, 106a, 106b, 108a, 108b, 110a, 110b, extending contiguously from one another to define an octagon-shaped EM radiator 102.

Aspect 2. The antenna 100 of Aspect 1, wherein the substrate 150 extends from a first substrate end 152a to an opposing second substrate end 152b along a first axis, X-axis, to define a substrate length, Subx, and extends from a third substrate end 154a to a fourth substrate end 154b along the second axis, Y-axis, to define a substrate width, Suby, and further extends from a lower substrate surface 156a to an upper substrate surface 156b along the third axis, Z-axis, to define a substrate thickness, Subz.

Aspect 3. The antenna 100 of any one of Aspects 1 to 2, wherein: the substrate length, Subx, is equal to or greater than 47.0 (millimeters) mm and equal to or less than 50.0 mm, alternatively is equal to or greater than 48.0 mm and equal to or less than 49.0 mm, and further alternatively is equal to 49.96 mm; the substrate width, Suby, is equal to or greater than 47.0 mm and equal to or less than 50.0 mm, alternatively is equal to or greater than 48.0 mm and equal to or less than 49.0 mm, and further alternatively is equal to 49.96 mm; and the substrate thickness, Subz, is equal to or greater than 6.0 mm and equal to or less than 10.0 mm, alternatively is equal to or greater than 7.0 mm and equal to or less than 9.0 mm, and further alternatively is equal to 8.0 mm.

Aspect 4. The antenna 100 of any one of Aspects 1 to 3, wherein the antenna 100 is a patch antenna.

Aspect 5. The antenna 100 of any one of Aspects 1 to 4, wherein the magnetodielectric material comprises a hexagonal ferrite particles and PTFE or PPS polymer.

Aspect 6. The antenna 100 of Aspect 5, wherein the hexagonal ferrite material includes Z-type (Co2Z), or Y-type (Co2Y) hexaferrite.

Aspect 7. The antenna 100 of any one of Aspects 1 to 6, wherein the substrate 150 is a single layer comprising the magnetodielectric material.

Aspect 8. The antenna 100 of any one of Aspects 1 to 7, wherein the EM radiator 102 defines a chamfer function based on the plurality of chamfered sides 104a, 104b, 106a, 106b, 108a, 108b, 110a, 110b.

Aspect 9. The antenna 100 of Aspect 8, wherein the chamfer function utilizes a vertex of the EM radiator 102 as a reference point and removes metallic portions of the EM radiator to achieve edge truncation of the EM radiator 102 to define the chamfered sides 104a, 104b, 106a, 106b, 108a, 108b, 110a, 110b, which control radiating modes of the EM radiator 102 at specific frequencies.

Aspect 10. The antenna 100 of Aspect 9, wherein adjusting the chamfer function increases or decreases an effective aperture of the EM, radiator 102 for a specific frequency.

Aspect 11. The antenna 100 of any one of Aspects 1 to 7, wherein the plurality of chamfered sides 104a, 104b, 106a, 106b, 108a, 108b, 110a, 110b includes: a first chamfered side 104a arranged adjacent to the third substrate end 154a; a second chamfered side 104b arranged opposite and parallel to the first chamfered side 104a and adjacent to the fourth substrate end 154b, the first and second chamfered sides 104a and 104b extending parallel to the first axis, X-axis, to define a first side length, L1; a third chamfered side 106a arranged adjacent to the first substrate end 152a; a fourth chamfered side 106b arranged opposite and parallel to the third chamfered side 106a and adjacent to the second substrate end 152b, the third and fourth chamfered sides 106a and 106b extending parallel to the second axis, Y-axis, to define a second side length, L2; a fifth chamfered side 108a extending from the first chamfered side 104a to the third chamfered side 106a at a distance defining a third side length, L3; a sixth chamfered side 108b arranged opposite and parallel to the fifth chamfered side 108a and extending from the second chamfered side 104b to the fourth chamfered side 106b at the distance defining the third side length, L3; a seventh chamfered side 110a extending from the first chamfered side 104a to the fourth chamfered side 106b at a distance defining a fourth side length, L4; and an eighth chamfered side 110b arranged opposite and parallel to the seventh chamfered side 110a and extending from the third chamfered side 106a to the second chamfered side 104b at the distance defining the fourth side length, L4.

Aspect 12. The antenna of Aspect 11, wherein a combination of the first side length L1, the second side length L2, and the third side length L3, controls an operating performance of the antenna 102 in the L2 and L5 bands, and the fourth side length L4 controls the operating performance of the antenna in the L1 band.

Aspect 13. The antenna 100 of Aspect 12, wherein: the first side length, L1, and the second side length, L2, are greater than the third side length, L3; and, wherein the fourth side length, L4, is greater than the first side length, L1, the second side length, L2, and the third side length, L3.

Aspect 14. The antenna 100 of Aspect 13, wherein: the first side length, L1 is equal to or greater than 15.0 mm (millimeters) and equal to or less than 20.0 mm, alternatively is equal to or greater than 17.0 mm and equal to or less than 18.0 mm, and further alternatively is equal to 17.46 mm; the second side length, L2 is equal to or greater than 15.0 mm and equal to or less than 20.0 mm, alternatively is equal to or greater than 17.0 mm and equal to or less than 18.0 mm, and further alternatively is equal to 17.46 mm; the third side length, L3, and is equal to or greater than 7.0 mm and equal to or less than 11.0 mm, alternatively is equal to or greater than 8.0 mm and equal to or less than 9.0 mm, and further alternatively is equal to 9.9 mm; and the fourth side length, L4 is equal to or greater than 30.0 mm and equal to or less than 33.0 mm, alternatively is equal to or greater than 31.0 mm and equal to or less than 32.0 mm, and further alternatively is equal to 31.82 mm.

Aspect 15. The antenna 100 of Aspect 14, wherein: the first chamfered side 104a and the second chamfered side 104b are each located a first distance, C_L1_{Distance}, away from the center point, C; the third chamfered side 106a and the fourth chamfered side 106b are each located a second distance, C_L2_{Distance}, away from the center point, C; the fifth chamfered side 108a and the sixth chamfered side 108b are each located a third distance, C_L3_{Distance}, away from the center point, C; and, the seventh chamfered side 110a and the eighth chamfered side 110b are each located a fourth distance, C_L4_{Distance}, away from the center point, C.

Aspect 16. The antenna 100 of Aspect 15, wherein: the first distance, C_L1_{Distance}, is equal to or greater than 21.0 mm and equal to or less than 25.0 mm, alternatively is equal to or greater than 22.0 mm and equal to or less than 24.0 mm, and further alternatively is equal to 23.48 mm; the second distance, C_L2_{Distance}, is equal to or greater than 21.0 mm and equal to or less than 25.0 mm, alternatively is equal to or greater than 22.0 mm and equal to or less than 24.0 mm, and further alternatively is equal to 23.48 mm; the third distance, C_L3_{Distance}, is equal to or greater than 27.0 mm and equal to or less than 30.0 mm, alternatively is equal to or greater than 28.0 mm and equal to or less than 29.0 mm, and further alternatively is equal to 28.25 mm; and the fourth distance, C_L4_{Distance}, is equal to or greater than 16.0 mm and equal to or less than 20.0 mm, alternatively is equal to or greater than 17.0 mm and equal to or less than 18.0 mm, and further alternatively is equal to 17.29 mm.

Aspect 17. The antenna 100 of any one of Aspects 1 to 16, wherein the substrate 150 includes a permittivity of (ε), equal to or greater than 2.0 and equal to or less than 7.0, alternatively equal to or greater than 3.0 and equal to or less than 6.0, further alternatively equal to or greater than 4.0 and equal to or less than 5.0, and is further alternatively equal to 4.96.

Aspect 18. The antenna 100 of any one of Aspects 1 to 17, wherein the substrate 150 includes a permeability (μ) equal to or greater than 0.5 and equal to or less than 3, alternatively equal to or greater than 1 and equal to or less than 2, further alternatively equal to or greater than 1.6 and equal to or less than 1.8, and is further alternatively equal to 1.61.

Aspect 19. The antenna 100 of any one of Aspects 1 to 18, wherein the substrate has a loss tangent parameter (tan δ) equal to or greater than 0.001 and equal to or less than 0.015, alternatively equal to or greater than 0.005 and equal to or less than 0.01, and is further alternatively equal to 0.009.

Aspect 20. The antenna 100 of Aspects 1 to 19 wherein the substrate has a magnetic loss tangent (tan μ) equal to or greater than 0.01 and equal to or less than 0.09, alternatively equal to or greater than 0.02 and equal to or less than 0.05, and further alternatively equal to 0.03.

Aspect 21. An antenna assembly 250, comprising: the antenna 100 of any one of Aspects 1 to 20, and further comprising: a host board 200 including an upper dielectric surface 202a and a lower dielectric surface 202b located opposite the upper dielectric surface 202a, wherein the substrate 150 is disposed on the upper dielectric surface 202a.

Aspect 22. The antenna assembly 250 of Aspect 21 wherein the host board 200 extends along the first axis from a first board end 202a to an opposing second board end 202b to define a board length, grndx, extends along the second axis from a third board end 204a to an opposing fourth board end 204b to define a board width, grndy, and extends along the third axis from the upper dielectric surface 206a to the lower dielectric surface 206b to define a board thickness, grndz.

Aspect 23. The antenna assembly 250 of any one of Aspects 21 to 22, further comprising an electrically conductive via 158 extending through the EM radiator 102, the substrate 150, and the host board, 200, the via configured to establish electrical conductivity with the EM radiator 102 and the substrate 150.

Aspect 24. The antenna assembly 250 of Aspect 23, wherein the via 158 has a circular profile defining a via diameter, ViaD.

Aspect 25. The antenna assembly 250 of any one of Aspects 23 to 24, wherein the via diameter, ViaD, is equal to or greater than 0.5 mm and equal to or less than 3.0 mm, alternatively is equal to or greater than 1.0 mm and equal to or less than 2.0 mm, and further alternatively is equal to 1.27 mm.

Aspect 26. The antenna assembly 250 of any one of Aspects 23 to 25, wherein the via 158 is located a distance away from a center point, C, of the EM radiator 102 to define a via distance, PX.

Aspect 27. The antenna assembly 250 of any one of Aspects 23 to 26, wherein the via distance is equal to or greater than 19.0 mm and equal to or less than 23.0 mm, alternatively is equal to or greater than 20.0 mm and equal to or less than 22.0 mm further alternatively is equal to 21.0 mm.

Aspect 28. The antenna assembly of any one of Aspects 1 to 27, wherein the antenna 100 is operational over at least three frequency bands.

Aspect 29. The antenna assembly 250 of Aspect 28, wherein the antenna 100 is operational to discriminate frequencies between individual ones of the at least three frequency bands.

Aspect 30. The antenna assembly 250 of any one of Aspects 28 to 29, wherein a first of the at least three frequency bands is a L5 band.

Aspect 31. The antenna assembly 250 of any one of Aspects 28 to 30, wherein a second of the at least three frequency bands is a L2 band.

Aspect 32. The antenna assembly 250 of any one of Aspects 28 to 31, wherein a third of the at least three frequency bands is a L1 band.

Aspect 33. The antenna assembly 250 of Aspect 32, wherein the L5 band is operational at a nominal center frequency of 1.176 GHz with a bandwidth of 12.5 MHz.

Aspect 34. The antenna assembly 250 of Aspect 33, wherein the L2 band is operational at a nominal center frequency of 1.227 GHz with a bandwidth of 11 MHz.

Aspect 35. The antenna assembly 250 of Aspect 34, wherein the L1 band is operational at a nominal center frequency of 1.575 GHz with a bandwidth of 15.3 MHz.

Aspect 36. The antenna assembly 250 of any one of Aspects 1 to 31, wherein the antenna 100 is operational with a gain equal to or greater than 3 dBi at each respective operational band.

Aspect 37. The antenna assembly 250 of any one of Aspects 1 to 36, wherein the antenna 100 is operational with an axial ratio equal to or less than 6 dBi, alternatively equal to or less than 3 dBi, at +/−30-degrees from each radiation boresight of the antenna 100.

Aspect 38. The antenna assembly 250 of any one of Aspects 1 to 37, wherein the antenna 100 is operational with right-hand-circular-polarization.

Aspect 39. The antenna assembly 250 of any one of Aspects 1 to 38, wherein the antenna 100 is operational with an efficiency of equal to or greater than 50%.

Aspect 40. The antenna assembly 250 of any one of Aspects 32 to 39, wherein the antenna 100 is operational with an efficiency greater than 60% within one or both of the L2 band and the L5 band.

Aspect 41. The antenna assembly 250 of Aspect 40, wherein the antenna 100 is operational with a maximum efficiency of 67% within one or both of the L2 band and the L5 band.

Aspect 42. The antenna assembly 250 of any one of Aspects 40 to 41, wherein the antenna 100 is operational with an efficiency greater than 60% within the L1 band.

Aspect 43. The antenna assembly 250 of any one of Aspects 1 to 42, wherein the antenna 100 is operational with an efficiency of equal to 68.2% at a frequency equal to or greater than 1.60 GHz and equal to or less than 1.61 GHz, and alternatively equal to 1.602 GHz.

Aspect 44. The antenna assembly 250 of any one of Aspects 1 to 43, wherein the antenna 100 is operational at a broad axial ratio bandwidth at 3 dBi of equal to or greater than 10 MHz, alternatively equal to or greater than 50 MHz, further alternatively equal to or greater than 100 MHz.

As used herein, the phrase “equal to about” is intended to account for manufacturing tolerances and/or insubstantial deviations from a nominal value that do not detract from a purpose disclosed herein and falling within a scope of the appended claims. All ranges are inclusive of the endpoints. The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, which are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

In general, the compositions, methods, and articles can alternatively comprise, consist of, or consist essentially of, any ingredients, steps, or components herein disclosed. The compositions, methods, and articles can additionally, or alternatively, be formulated, conducted, or manufactured so as to be devoid, or substantially free, of any ingredients, steps, or components not necessary to the achievement of the function or objectives of the present claims.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.

The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named.

Unless defined otherwise, technical and scientific terms used herein have the same meaning as is commonly understood by one of skill in the art to which this invention belongs.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. Any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art. Accordingly, the appended claims as filed and as they may be amended are intended to embrace all such alternatives, modifications variations, improvements, and substantial equivalents.

What is claimed is:

1. An antenna, comprising:
a substrate comprising a magnetodielectric material; and
an electromagnetic, EM, radiator comprising an electrically conductive material disposed on an upper surface of the substrate, the EM radiator including a plurality of chamfered sides extending contiguously from one another to define an octagon-shaped EM radiator.

2. The antenna of claim 1, wherein:
the substrate extends from a first substrate end to an opposing second substrate end parallel to first axis, X-axis, to define a substrate length, Subx, and extends from a third substrate end to a fourth substrate end parallel to the second axis, Y-axis, to define a substrate width, Suby, and further extends from a lower substrate surface to an upper substrate surface parallel to the third axis, Z-axis, to define a substrate thickness, Subz;
wherein the X, Y, and Z, axes form an orthogonal X-Y-Z coordinate system.

3. The antenna of claim 1, wherein the antenna is a patch antenna.

4. The antenna of claim 1, wherein the magnetodielectric material comprises hexagonal ferrite particles and PTFE or PPS polymer.

5. The antenna of claim 4, wherein the hexagonal ferrite material includes Z-type (Co2Z), or Y-type (Co2Y) hexaferrite.

6. The antenna of claim 1, wherein the substrate is a single layer comprising the magnetodielectric material.

7. The antenna of claim 1, wherein the EM radiator defines a chamfer function based on the plurality of chamfered sides.

8. The antenna of claim 7, wherein the chamfer function utilizes a vertex of the EM radiator as a reference point and removes metallic portions of the EM radiator to achieve edge truncation of the EM radiator to define the chamfered sides, which control radiating modes of the EM radiator at specific frequencies.

9. The antenna of claim 8, wherein adjusting the chamfer function increases or decreases an effective aperture of the EM, radiator for a specific frequency.

10. The antenna of claim 1, wherein the plurality of chamfered sides includes:
a first chamfered side arranged adjacent to the third substrate end;
a second chamfered side arranged opposite and parallel to the first chamfered side and adjacent to the fourth substrate end, the first and second chamfered sides extending parallel to the first axis, X-axis, to define a first side length, L1;
a third chamfered side arranged adjacent to the first substrate end;
a fourth chamfered side arranged opposite and parallel to the third chamfered side and adjacent to the second substrate end, the third and fourth chamfered sides extending parallel to the second axis, Y-axis, to define a second side length, L2;
a fifth chamfered side extending from the first chamfered side to the third chamfered side at a distance defining a third side length, L3;
a sixth chamfered side arranged opposite and parallel to the fifth chamfered side and extending from the second chamfered side to the fourth chamfered side at the distance defining the third side length, L3;
a seventh chamfered side extending from the first chamfered side to the fourth chamfered side at a distance defining a fourth side length, L4; and
an eighth chamfered side arranged opposite and parallel to the seventh chamfered side and extending from the third chamfered side to the second chamfered side at the distance defining the fourth side length, L4.

11. The antenna of claim 10, wherein a combination of the first side length L1, the second side length L2 and the third side length L3 controls an operating performance of the antenna 102 in the L2 and L5 bands, and the fourth side length L4 controls the operating performance of the antenna in the L1 band.

12. The antenna of claim 11, wherein:
the first side length, L1, and the second side length, L2, are greater than the third side length, L3; and
wherein the fourth side length, L4, is greater than the first side length, L1, the second side length, L2, and the third side length, L3.

13. The antenna of claim 10, wherein:
the first chamfered side and the second chamfered side are each located a first distance, C_L1_{Distance}, away from the center point, C;
the third chamfered side and the fourth chamfered side are each located a second distance, C_L2_{Distance}, away from the center point, C;
the fifth chamfered side and the sixth chamfered side are each located a third distance, C_L3_{Distance}, away from the center point, C; and
the seventh chamfered side and the eighth chamfered side are each located a fourth distance, C_L4_{Distance}, away from the center point, C.

14. The antenna of claim 1, wherein the substrate includes a permittivity of (ε), equal to or greater than 2.0 and equal to or less than 7.0, and a permeability (μ) equal to or greater than 0.5 and equal to or less than 3.

15. The antenna of claim 1, wherein the substrate has a loss tangent parameter (tan δ) equal to or greater than 0.001 and equal to or less than 0.015, and a magnetic loss tangent (tan μ) equal to or greater than 0.01 and equal to or less than 0.09.

16. An antenna assembly, comprising:
the antenna of claim 1, and further comprising:
a host board including an upper dielectric surface and a lower dielectric surface located opposite the upper dielectric surface,
wherein the substrate is disposed on the upper dielectric surface.

17. The antenna assembly of claim 16, further comprising an electrically conductive via extending through the EM radiator, the substrate, and the host board, the via configured to establish electrical conductivity with the EM radiator and the substrate.

18. The antenna assembly of claim 1, wherein the antenna is operational over at least three frequency bands.

19. The antenna assembly of claim 18, wherein the antenna is operational to discriminate frequencies between individual ones of the at least three frequency bands.

20. The antenna assembly of claim 18, wherein a first of the at least three frequency bands is a L5 band.

21. The antenna assembly of claim 18, wherein a second of the at least three frequency bands is a L2 band.

22. The antenna assembly of claim 18, wherein a third of the at least three frequency bands is a L1 band.

23. The antenna assembly of claim 1, wherein the antenna is operational with a gain equal to or greater than 3 dBi at each respective operational band.

24. The antenna assembly of claim 1, wherein the antenna is operational with an axial ratio equal to or less than 6 dBi, alternatively equal to or less than 3 dBi, at +/−30-degrees from each radiation boresight of the antenna.

25. The antenna assembly of claim 1, wherein the antenna is operational with right-hand-circular-polarization.

26. The antenna assembly of claim 22, wherein the antenna is operational with an efficiency greater than 60% within one or more of the L1 band, the L2 band, and the L5 band.

27. The antenna assembly of claim 1, wherein the antenna is operational at a broad axial ratio bandwidth at 3 dBi of equal to or greater than 10 MHz.
